(19) United States
(12) Patent Application Publication
(10) Pub. No.: US 2012/0259594 A1
(43) Pub. Date: Oct. 11, 2012

(54) BIM BASED 3-D VISUALIZATION

(76) Inventors: Azam KHAN, Aurora (CA); Michael Glueck, Toronto (CA); Alexander Tessier, Toronto (CA); Ramtin Attar, Toronto (CA)

(21) Appl. No.: 13/083,430

(22) Filed: Apr. 8, 2011

(51) Int. Cl. G06F 17/50

(52) U.S. Cl. 703/1

(57) ABSTRACT

A system and a computer implemented method of 3-D visualization of a building module is disclosed. The method includes receiving attributes of the building module from a building information model and receiving data inputs from a plurality of sensors located in the building module. Locations of at least a subset of the plurality of sensors in the building module and types and locations of physical objects in the building module are determined. Then, a 3-D visualization of the building module on a computer screen is generated based on the attributes of the building module, the locations of the physical objects, the locations of at least the subset of the plurality of sensors and the data inputs from the plurality of sensors.

### BACKGROUND OF THE INVENTION

1. Field of the Invention

Embodiments of the present invention relate generally to a computer-implemented method for generating visual representations of building modules and more particularly creating a computing dashboard for displaying 3-D visualization of building related data.

2. Description of the Related Art

Building Information Model (BIM) is a building design methodology characterized by the creation and use of coordinated, internally consistent computable information about a building project in design and construction. BIM methodology employs objects that may be abstract or conceptual, and produces data models that include building geometry, spatial relationships, geographic information, and quantities and properties of building components.

Many BIM authoring tools or software tools are available to create the BIM data models for buildings. A building architect may use these tools to create modular objects representing building modules. For example, an architect may create a model object of a room in which the characteristics and attributes of the room need to be defined only once. Once defined, the model object can then be moved, used and re-used as appropriate. BIM design tools then allow for extracting different views from a building model for drawing production and other uses. These different views are automatically consistent—in the sense that the objects are all of a consistent size, location, specification—since each object instance is defined only once.

BIM data models are typically stored in Industry Foundation Classes (IFC) format to facilitate interoperability in the building industry. The IFC format is a data representation standard and file format used to define architectural and construction-related CAD graphic data as 3D real-world objects. The main purpose of the IFC format is to provide architects and engineers with the ability to exchange data between CAD tools, cost estimation systems and other construction-related applications. The IFC standard provides a set of definitions for some or all object element types encountered in the building industry and a text-based structure for storing those definitions in a data file. The IFC format also allows a BIM data model author to add locations and types of sensors in a building. Modern BIM systems are able to create rich internal representations on building components. The IFC format adds a common language for transferring that information between different BIM applications while maintaining the meaning of different pieces of information in the transfer. This reduces the need of remodeling the same building in each different application.

Although visualization techniques have been used to interpret BIM data models, such techniques have been limited to 2D graphs or abstract numerical outputs. In particular, existing building dashboard systems, that visualize information collected from sensors distributed throughout a building, typically show the raw data values as simple text labels on 2D floor plans, this reduction in data access makes it very difficult for users to understand complex interacting factors that effect overall building performance. Furthermore, current visualization techniques generally do not directly relate spatial and non-spatial data.

Another limitation of a typical building performance data visualization methodology is that occupants are generally treated as “passive participants” within an environment controlled through a centralized automation system, and the entire interior space is generally treated as a homogenous environment.

### SUMMARY OF THE INVENTION

One embodiment of the present invention sets forth a system and a computer implemented method of 3-D visualization of a building module is disclosed. The method includes receiving attributes of the building module from a building information model and receiving data inputs from a plurality of sensors located in the building module. Locations of at least a subset of the plurality of sensors in the building module and types and locations of physical objects in the building module are determined. Then, a 3-D visualization of the building module on a computer screen is generated based on the attributes of the building module, the locations of the physical objects, the locations of at least the subset of the plurality of sensors and the data inputs from the plurality of sensors.

In another embodiment, a computer generated visualization dashboard is disclosed. The dashboard includes a 3-D rendering of a building module that includes geometrical features of the building module and one or more moveable physical objects inside the building module. The dashboard also includes a graphical representation of a source of an environmental element inside the building module including a direction of flow of the environmental element and intensity of the environmental element corresponding to the flow.

In yet another embodiment, a method of generating a 3-D representation of a building module is disclosed. The method includes selecting the building module from a plurality of building modules through a user interface on a computer screen. A user may provide an input, through the user interface, to trigger the computer screen to display a 3-D representation of the building module. The 3-D representation of the building module includes geometrical features of the building module. The user may also provide an input, through the user interface, to trigger the computer screen to display a graphical representation of an environment element in the 3-D representation.

Other embodiments include, without limitation, a computer-readable medium that includes instructions that enable a processing unit to implement one or more aspects of the disclosed methods as well as a system configured to implement one or more aspects of the disclosed methods.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a logical diagram of a visualization processor, according to one embodiment of the present invention.

FIG. 2 is a logical diagram of a system for 3-D visualization of building data, according to one embodiment of the present invention.

FIG. 3 illustrates a flow diagram for processing data inputs from sensors, according to one embodiment of the present invention.

FIGS. 4A-4C illustrate 3-D visualizations, accordingly to one embodiment of the present invention.

FIG. 5 illustrates a flow diagram of a method of 3-D visualization of building module, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Reference throughout this disclosure to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

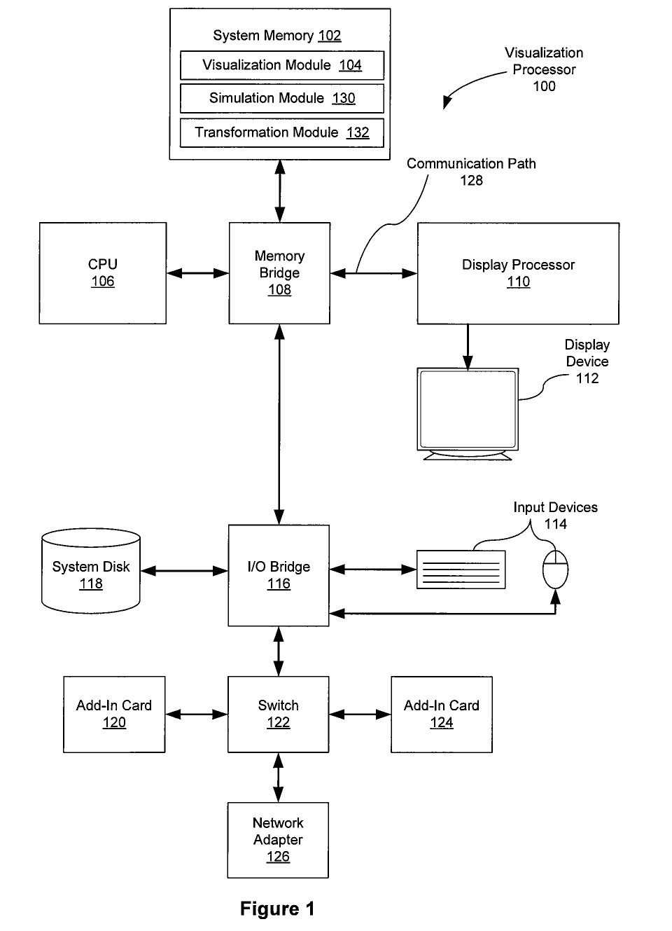

FIG. 1 illustrates an exemplary visualization processor 100 configured to implement one or more aspects of the present invention. Visualization processor 100 may be a computer workstation, personal computer, video game console, personal digital assistant, rendering engine, mobile phone, hand held device, smart phone, super-smart phone, or any other device suitable for practicing one or more embodiments of the present invention.

As shown, visualization processor 100 includes one or more processing units, such as central processing unit (CPU) 106, and a system memory 102 communicating via a bus path 128 that may include a memory bridge 108. CPU 106 includes one or more processing cores, and, in operation, CPU 106 is the master processor of visualization processor 100, controlling and coordinating operations of other system components. System memory 102 stores software applications (e.g., a visualization module 104, a simulation module 130 and a transformation module 132) and data for use by CPU 106. Simulation module 130 provides programming logic for calculating additional data points based on input data from sensors. Transformation module 132 is used to transform input data from sensors to conform to the requirements of visualization module 104, which renders 3-D visualization based on BIM data models, input data from sensors and additional data points generated by simulation module 130. CPU 106 runs software applications and optionally an operating system. Memory bridge 108, which may be, e.g., a Northbridge chip, is connected via a bus or other communication path (e.g., a HyperTransport link) 128 to an I/O (input/output) bridge 116. I/O bridge 116, which may be, e.g., a Southbridge chip, receives user input from one or more user input devices 114 (e.g., keyboard, mouse, joystick, digitizer tablets, touch pads, touch screens, still or video cameras, motion sensors, and/or microphones) and forwards the input to CPU 106 via memory bridge 108.

In one embodiment, visualization processing module 104 is stored in system memory 102. visualization processing module 104 may be any application that when executed on CPU 106 processes input data and generates 3-D visualization on a computer terminal. In alternative embodiments, visualization processing module 104 may be a Web application, that is stored on a remote server and accessed through network adapter 126.

One or more display processors, such as display processor 110, are coupled to memory bridge 108 via a bus or other communication path 128 (e.g., a PCI Express, Accelerated Graphics Port, or HyperTransport link); in one embodiment display processor 110 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 110 periodically delivers pixels to a display device 112 (e.g., a screen or conventional CRT, plasma, OLED, SED or LCD based monitor or television). Additionally, display processor 110 may output pixels to film recorders adapted to reproduce computer generated images on photographic film. Display processor 110 can provide display device 112 with an analog or digital signal.

A system disk 118 may also connected to I/O bridge 116 and may be configured to store content and applications and data for use by CPU 106 and display processor 110. System disk 118 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 122 provides connections between I/O bridge 116 and other components such as a network adapter 126 and various add-in cards 120 and 124. Network adapter 126 allows computer system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 116. For example, an audio processor may be used to generate analog or digital audio output from instructions and/or data provided by CPU 106, system memory 102, or system disk 118. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 110 incorporates circuitry optimized for 3-D graphics simulations and video processing, including, for example, video output circuitry, and constitutes a graphics processing unit (GPU). In another embodiment, display processor 110 incorporates circuitry optimized for general purpose processing. In yet another embodiment, display processor 110 may be integrated with one or more other system elements, such as the memory bridge 108, CPU 106, and I/O bridge 116 to form a system on chip (SoC). In still further embodiments, display processor 110 is omitted and software executed by CPU 106 performs the functions of display processor 110.

Pixel data can be provided to display processor 110 directly from CPU 106. In some embodiments of the present invention, instructions and/or data representing a scene are provided to a render farm or a set of server computers, each similar to computer system 100, via network adapter 126 or system disk 118. The render farm generates one or more rendered images of the scene using the provided instructions and/or data. These rendered images may be stored on computer-readable media in a digital format and optionally returned to computer system 100 for display. Similarly, stereo image pairs processed by display processor 110 may be output to other systems for display, stored in system disk 118, or stored on computer-readable media in a digital format.

Alternatively, CPU 106 provides display processor 110 with data and/or instructions defining the desired output images, from which display processor 110 generates the pixel data of one or more output images, including characterizing and/or adjusting the offset between stereo image pairs. The data and/or instructions defining the desired output images can be stored in system memory 102 or graphics memory within display processor 110. In an embodiment, display processor 110 includes 3D rendering capabilities for generating pixel data for output images from instructions and data defining the geometry, lighting shading, texturing, motion, and/or camera parameters for a scene. Display processor 110 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, system memory 102 is connected to CPU 106 directly rather than through a bridge, and other devices communicate with system memory 102 via memory bridge 108 and CPU 106. In other alternative topologies display processor 110 is connected to I/O bridge 116 or directly to CPU 106, rather than to memory bridge 108. In still other embodiments, I/O bridge 116 and memory bridge 108 might be integrated into a single chip. The particular components shown herein are optional; for instance, any number of add-in cards or peripheral devices might be supported. In some embodiments, switch 122 is eliminated, and network adapter 126 and add-in cards 120, 124 connect directly to I/O bridge 116.

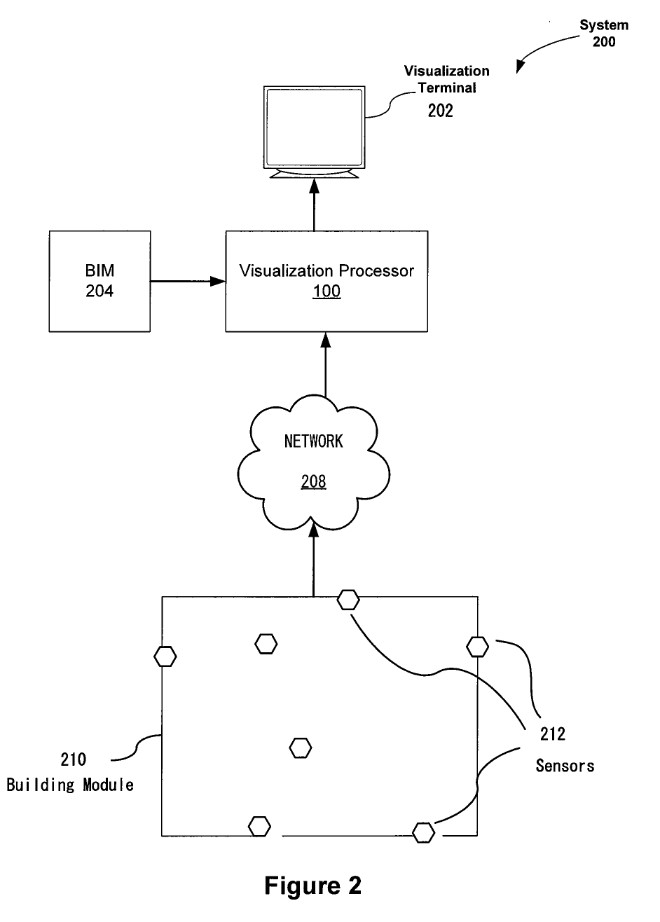

FIG. 2 is a logical diagram of a system 200 for 3-D visualization of building data, according to one embodiment. Accordingly, system 200 includes a visualization terminal 202 and a visualization processor 100 that is coupled to a Building Information Modeling system 204. In one embodiment, visualization terminal 202 and visualization processor 100 may be implemented in a same computing system. A plurality of sensors 212 may be installed at different locations in a building module 210. As described herein, building module 210 may be an entire building or buildings, or a portion of the building, such as a floor, room, or cubicle. Some sensors 212 may be embedded in physical objects inside or in the proximity of building module 210. Building module 210 is a part of a building that corresponds to one or more objects (BIM data models) in Building Information Model (BIM) system 204 for the building. BIM system 204 includes BIM data models corresponding to various parts of the building. Accordingly, BIM system 204 includes one or more BIM data models corresponding to building module 210. In one embodiment, BIM data models define bounding boxes (e.g., building module 210) and objects therein and may also includes one or more attributes of objects of building module 210. Further, in one aspect, system 200 semantically links objects in real world (e.g., office cube and physical objects inside an office cube, sensors, etc.) to BIM data models stored in BIM system 204. In one embodiment, some or all physical objects in building module 210 may include embedded one or more types of sensors. Some exemplary types of sensors include Radio Frequency Identification (RFID) tags, temperature sensors, gas sensors, current sensors, voltage sensors, power sensors, humidity sensors, etc. RFID tags may be active or passive depending upon a particular configuration of building module 210 and locations of RFID readers in and around building module 210. In one embodiment, BIM data models are represented in the industry standard IFC format. Some or all BIM data models may also include locations and types of sensors.

Visualization processor 100 and sensors 212 may be coupled together through a network 208. In one embodiment, sensors 212 includes necessary logic to couple directly with network 208. In an alternative embodiment, sensors 212 are coupled to network 208 through sensor readers (not shown). Sensor readers may be placed at various locations in the building to receive data inputs from sensors 212. Sensor readers may also include logic to convert data inputs from sensors 212 to a format that is suitable for network 208 and/or visualization processor 100. In yet another embodiment, some sensors may couple directly to network 208 and others may couple to network 208 through one or more sensor readers. Some types of sensors may require sensor readers. For example a RFID tag may need a RFID reader. Visualization processor 100 may include processing logic to calculate and determine locations of sensors 212 based on triangulation and/or geolocation methods. In other embodiments, a BIM data model corresponding to building module 210 may include sensor and physical object location attributes and visualization processor 100 may receive sensor locations from BIM system 204 based on the locations of physical objects to which the sensors are attached. In one embodiment, if a BIM data model or BIM data model does not include locations and types of some or all sensors 212, the BIM data model may be edited in a BIM authoring tool to include the necessary sensor location and type information. Furthermore, if the BIM data model includes a sensor which does not physically exist in the building or building module 210, the data related to this non-existent sensor may either be removed by editing the BIM data model or the sensor in question may be marked inactive.

In one example, building module 210 is an employee workspace (e.g., a cube or an office). In other examples, building module 210 could be any area of the building as long as BIM system 204 provides a corresponding BIM models or objects. In other embodiments, if BIM system 204 does not include an object representation of a particular part of the building, a BIM data model may be created in BIM system 204 based on the specifications of the particular part of the building. Visualization processor 100 leverages the semantic data available in a BIM data model to simulate and represent data in the 3D context. In one aspect, system 200 semantically links objects in the real world, such as sensors or cubicles, to objects found in BIM system 204. System 200 is not merely configured to display the data collected from sensors 212. System 200 is configured to aggregate and process the data collected from sensors 212 and simulate 3D data representation models.

In one embodiment, sensors 212 may be placed at random locations in building module 210. In another embodiment, sensors 212 are placed strategically in building module 210. For example, power sensors, current sensors and voltage sensors may be placed near electrical sources or coupled to electrical sources. Sensors 212 include different types of sensing and data collection devices. For examples, sensors may include one or more of temperature sensors, humidity sensors, voltage sensors, power sensors, gas sensors, air flow sensors and light sensors, location sensors. It should be noted that other types of sensors that can provide data related to one or more aspects of building monitoring are also within the scope of this disclosure. As noted above, at least some of sensors 212 may be embedded in physical objects inside building module 210. For example, sensors 212 may be embedded in chairs, tables, computers, electrical outlets, light sources, etc.

Sensors 212 may be coupled to one or more data collection modules (not shown). Sensors 212 and data collection modules may be placed at appropriate locations in or outside of building module 210 based on sensing ranges of data collection modules and sensors 212. In one embodiment, sensors 212 may be coupled to network 208 through wires. In another example, sensors 212 may include wireless transmitters and can transmit data over the air to one or more data collection modules in the vicinity of building module 210. In yet another embodiment, some sensors 212 may be wired and others may be wireless. Building module 210 may also include a local data collector which can be configured to collect data from some or all sensors 212 in building module 210. The local data collector may then be coupled to network 208 through global data collectors that are placed in the vicinity of building module 210. In one embodiment, the X, Y, Z coordinates of sensors 212 are manually entered in visualization processor 100, which processes the data collected by data collection modules and renders the 3-D visualization of building module 210 based on the data collected from sensors 212. In another embodiment, the X, Y, Z coordinates of sensors 212 are calculated by either data collectors in the vicinity of building module 210 or visualization processor 100 based on location data provided by data collectors or the corresponding BIM data model. In one embodiment, if sensor locations are not provided by corresponding BIM data models, a Wi-Fi triangulation method may be employed to calculate the X, Y, Z coordinates of sensors 212. In other embodiments, other geolocation methods and tools (e.g., GPS) may be employed. Geolocation is the identification of the real-world geographic location of an Internet-connected computer, mobile device, website visitor or other. In some embodiments, even if BIM models provide sensor locations and types, this information may still be collected using methods such as Wi-Fi triangulation and data type inputs form respective sensors because at least some sensors may be attached to moveable objects in building module 210 or in the building. Since visualization processor 100 is configured to associate locations of sensors 212 with BIM data model(s) of building module 210, visualization processor 100 is able to generate building module visualization significantly accurately compared to existing 2-D visualizations.

In one embodiment, a fault tolerance feature is employed in that if some sensors 212 fail or their connectivity to network 208 is disrupted, visualization processor 100 may interpolate or extrapolate data from other sensors 212 of similar types. In other embodiments, visualization processor 100 may be configured to maintain a value ranges for some or all types of collected data based on historical data collection. visualization processor 100 may be configured to disregard out of band values received from sensors 212 based on the previously determined value ranges for each type of collected data.

In one embodiment, visualization terminal 202 is a computing system that interfaces with visualization processor 100 to provide a visual 3-D representation of building module 210 and environmental conditions therein. Visualization terminal 202 receives display data from visualization processor 100 and displays the 3-D visualization of the received display data based on user configurations. Visualization terminal 202 may also be a computer terminal that is configured to be a graphical user interface to visualization processor 100. Visualization terminal 202 may be configured to present the received visualization data in different visual and/or textual forms on a display screen based on system and user configurations. The system and user configurations may include parameters to direct visualization terminal 202 to display the received visualization data using various color schemes, labels, sounds, alerts, graphs and other types of graphical representations. Visualization terminal 202 may also be configured to switch among different visual representations of the same visualization data according to user inputs.

Traditionally, data collected through sensors is displayed using 2-D graphs. These graphs facilitate the study of certain trends over time, but do not explain, for example, why the values of, for example, light sensor A and light sensor B, which are incorporated in a same building module, are so different from each other. However, by correlating the values to features found in a 3D visualization model of the building module, it becomes evident that, for example, one side of the building module is more exposed to direct sun light coming from the windows.

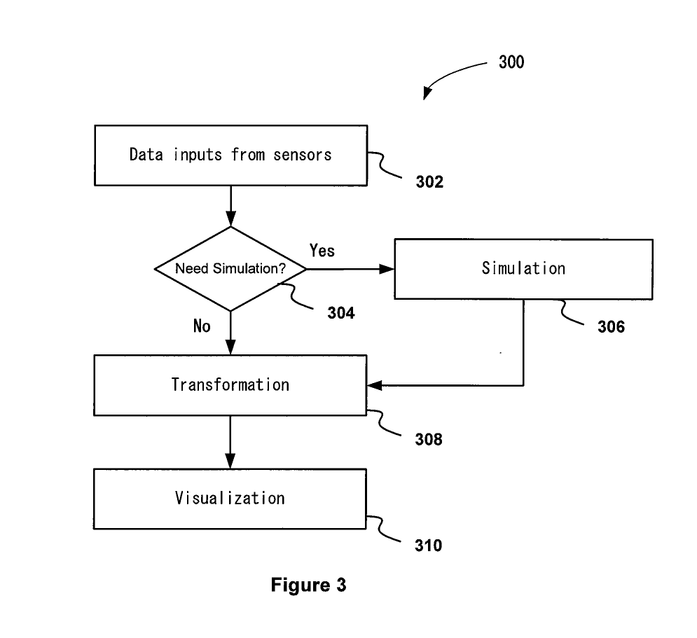

FIG. 3 illustrates a flow diagram 300 for processing data inputs from sensors, according to one embodiment of the present invention. Accordingly, at step 302, visualization processor 100 receives data inputs from some or all sensors 212. At decision step 304, visualization processor 304 determines if there is any need for producing additional data points based on at least some data inputs. If data simulation is needed, at step 306, additional data points are produced using simulation module 130. The additional data points are then supplied to transformation module 132 for a transformation. At step 308, transformation module 132 quantizes, biases, scales and filters the data according to the requirements of visualization module 104. Finally, at step 310, visualization module 104 produces 3-D visualization of building module 210 based on data inputs and simulated additional data points.

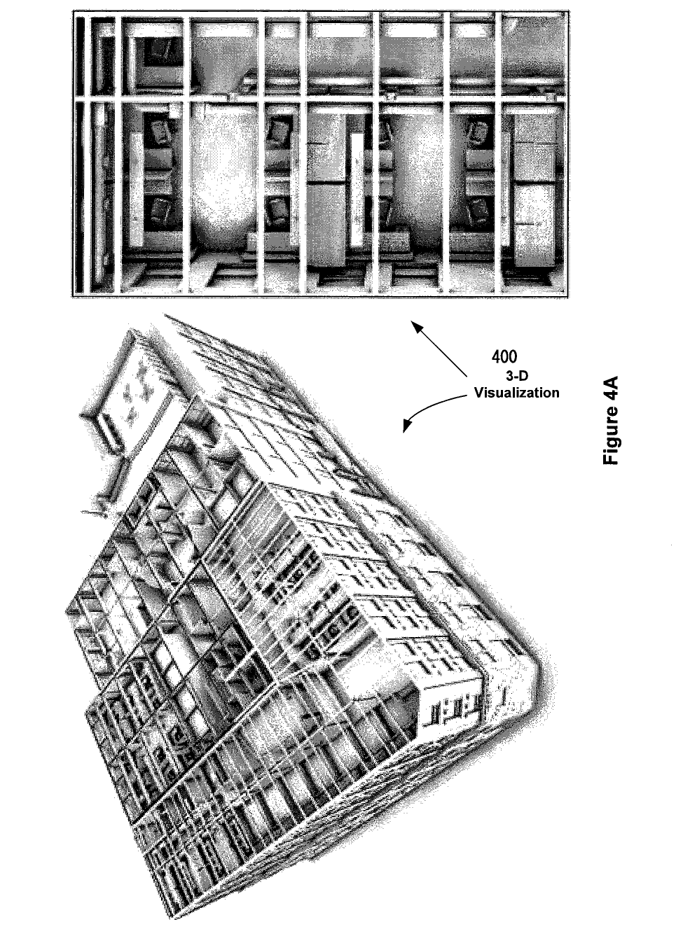

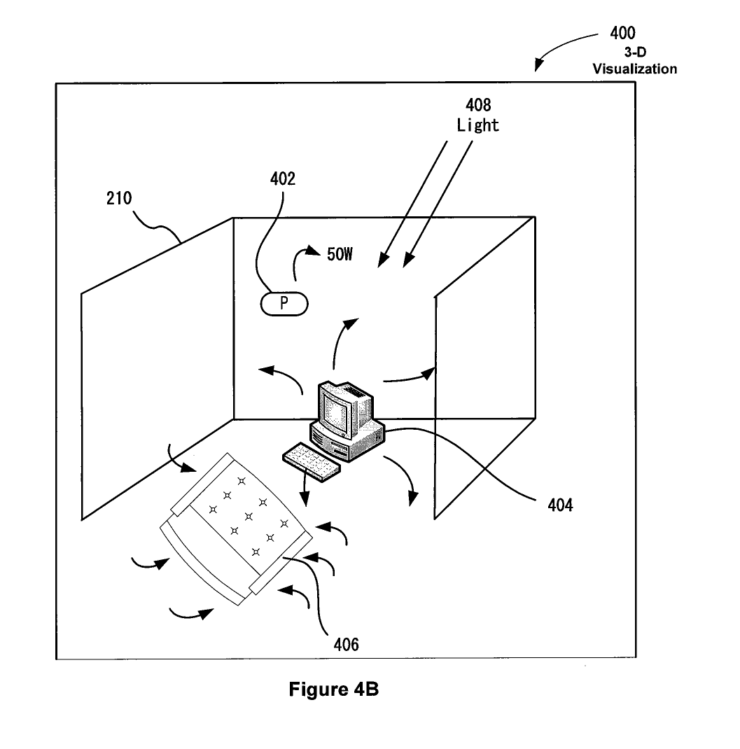

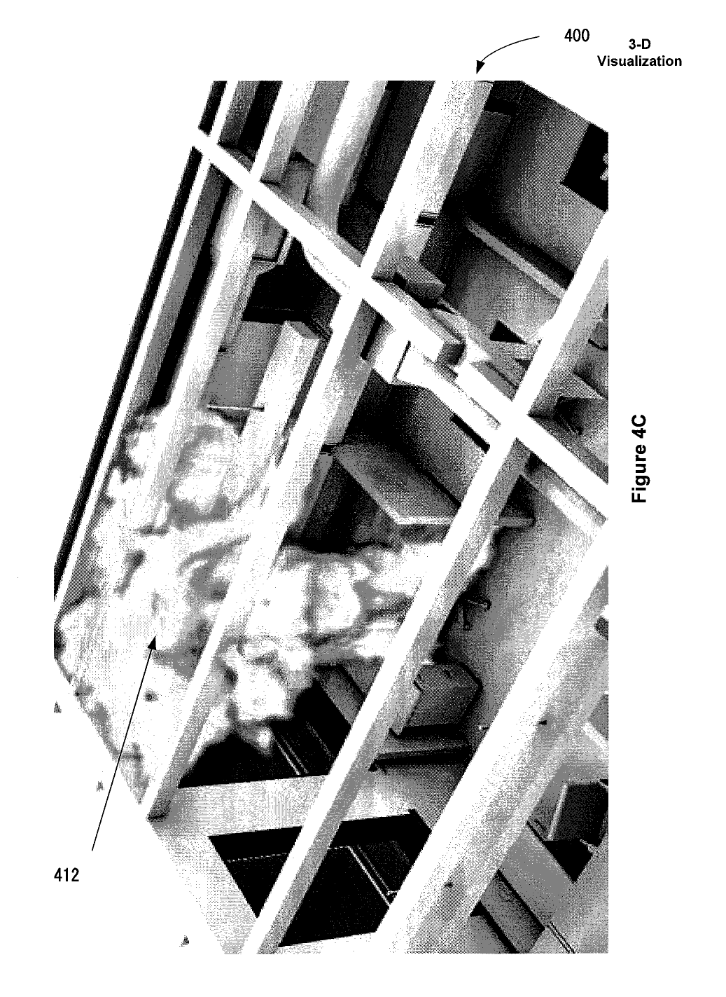

FIG. 4A illustrates an exemplary 3-D visualization 400 of a building which includes a plurality of building modules 210. 3D visualization 400 includes a detailed representation of the building geometry and provides a rich source of contextual information to a user. 3-D visualization 400 conveys to the user details of objects in the building, which includes a plurality of building modules 210. The user can select specific building modules 210 to view detailed visualization of the inside of the selected building module 210.

FIG. 4B illustrates an exemplary visualization of building module 210 based on the data collected from various sensors 212 that are located in or around building module 210. It should be noted that the data collected from various sensors is processed by visualization processor 100 to generate graphical presentations of visual objects that are then displayed in conjunction with corresponding BIM data models. For example, the location and direction of an arrow 408 that indicates the direction and source of the incoming light into building module 210, is calculated based on data inputs from one or more light sensors. In this example, visualization processor 100 calculates the direction and source based on light sensors located in and around building module 210 that provides light lumen values in the proximity of building module 210.

Data acquired from sensors or through data simulations based on input data from sensors can be described as either logical, scalar, vector or semantic. Logical data (typically, true or false) can be used to describe the presence or absence of certain object in a visualization. Scalar data pertains to continuous on-dimensional real values (e.g., temperature and energy usage). Vector data pertains to real values, with direction and magnitude (e.g., air velocity). Semantic data is used for tags and properties which identify geometry as building elements, such as walls, structure, HVAC, chairs, desks, windows, etc.

In one embodiment, a surface shading technique is used to calculate data values of some attributes in a space. Given a scalar field, a gradient shading can be applied to surfaces which attenuate with the distance and intensity of nearby data points. A sparse 3D scalar field can be visualized on surface geometry by computing an inverse distance weighted-sum between surface points and all the data points in the field. In one embodiment in which the visual representation include color shading, this sum is then mapped to color and used to shade the corresponding point. Temperature readings, for example, can be taken from different areas in the office and then mapped to provide an approximate visualization of temperature changes across the office (as represented by arrow in FIG. 4B). Power usage can be represented in the same way giving users the ability to quickly determine areas of high power consumption. Transient geometry refers to auxiliary geometry that is not originally present in the scene since it exists only so long as the visualization is presented to a user. The benefit of transient geometry over direct rendering methods is that visualizations are not limited to the surfaces of the existing geometry, thus more complex 3D data can be represented.

The simplest implementation of this group of methods is in the form of glyphs. Glyphs are symbolic representations of single data points, such as an arrow. Arrow glyphs can be used to represent discrete vector data samples making it is possible to visualize complex phenomenon, such as air movement through a space. Glyphs can also be used as an alternative to direct rendering methods of displaying logical data. For example, point marker glyphs can be used to mark particular points of interest in 3D space. In particular glyphs can be used to mark points whose data originated from a sensor reading. This differentiates mark points from points whose data values have been interpolated. Similarly, occupancy can also be visualized using glyphs. Using simple motion sensors and a small set of video cameras, building occupancy can be monitored. This data can then be represented using peg-like glyphs, which provide an abstract representation of occupants in a space. The combination of base and stem parts ensure that pegs are always visible from a variety of viewing directions, including head-on or from the top. Their abstract nature avoids conveying potentially misleading information about which direction the occupant is facing (this is not the case when representing occupants with human-like billboards). To reduce visual clutter, pegs are aggregated when they are within a certain radius of one another. Aggregated pegs are distinguished from single pegs by using a combination of colouring, text and segmentation of the inner ring.

In one embodiment, visualization terminal 202 may be configured to display some parameters using arrows or other types of visual objects that may provide similar representations. Color schemes may also be used in other embodiments. For example, a visual representation using a text label may be provided to real time display power usages associated with an electrical outlet 402. Alternatively and based on system and user configurations, an arrow may be used to indicate the same data. In other embodiments the color of electrical outlet 402 may be changed corresponding to power usages. For example, a green color may represent power usage within 0-20 W, orange for power usage within 21-50 W and so on.

Similarly, arrows may be used to represent heat sources and sinks. For example, a computer 404 is an exemplary heat source in FIG. 4B. The directions of arrows may indicate the direction of heat flow. For example, a chair 406 is shown to be a consumer of heat. In other embodiments, instead of arrows or in conjunction with arrows, color schemes may be used to show various temperature zones. In the example of FIG. 4B, the area around computer 404 may be shown in a different color depicting a head source. In one embodiment, the color depiction may gradually fade corresponding to a distance from the heat source. Similarly, a light terrain may also be displayed corresponding to light intensities in different parts of building module 210. Of course, a user may switch between visualizations of different types of data (e.g., light, heat, power) or may view them together.

In one embodiment, the visual representations, as described above, may be calculated based using mathematical models. For example, a heat dissipation mathematical model may take into consideration the locations of heat sensors, data inputs from these heat sensors, ambient temperature and humidity conditions and presence of heat sinks (such as furniture, etc. in building module 210) to provide a visual representation of temperature gradients in building module 210. For example, if building module 210 has one heat source, the temperature sensors at the heat source and in the vicinity can provide temperature readings at the sensor locations. Since the locations of these sensors are known, a temperature at any point in the space in building module 210 may be calculated using a heat dissipation mathematical model based on distance, humidity and other ambient environmental conditions inside and around building module 210. Such mathematical data modeling and grandient shading methods are well known in the art, hence a detailed disclosure is being omitted.

In one embodiment, sensors 212 may not be embedded in the objects inside building module 210. For example, in one embodiment, there may be no heat sensor directly attached to computer 404. In such embodiments, visualization processor 100 is configured to process the data from various heat sensors in and around building module 210 and information provided by BIM system 204 regarding object families to determine the location of heat sources.

In another embodiment, the objects in building module 210 may include identification tags (e.g. RFID tags). Building module 210 may be equipped with Radio Frequency Identification (RFID) readers to determine the identification of a particular object (e.g. computer 404) and the location thereof. The location of computer 404 may be determined using methods such as triangulation and geolocation. A use of RFID identification tags and readers enables moving the objects in and out of building module 210 without disrupting the functioning of system 200.

As noted above, visualization processor 100 is configured to process the data collected by a plurality of sensors 212, for example temperature sensors, and determine the heat sources and sinks in building module 210 based on determined locations of sensors 212 and physical objects (e.g., computers, chairs, light sources, etc.) in building module 210. For example, in FIG. 4B, heat sensors near chair 406 will provide lower reading than heat sensors near computer 404. Since the locations of sensors 212 are known, visualization processor 100 may calculate the direction of heat source based on varying temperature readings of heat sensors in building module 210. Even though temperature sensors are used the example, the foregoing methods may apply to other types of sensors.

FIG. 4C illustrates an exemplary 3-D visualization 412 of smoke or indoor air quality using a volume rendering technique. Note that even though the example refers to depiction of smoke, the same visualization technique may also be used for visualization of other phenomenon which include distribution of particles or distribution of discrete data points having different values. Volume rendering techniques enable high fidelity reconstruction of 3-D data fields such as particles or isosurfaces, for example, the diffusion of airborne contaminants using Computational Fluid Dynamics (CFD) model with boundary conditions that emit into a simulated volume at a rate approximating the diffusion of contaminants.

Additional data that cannot be displayed meaningfully within the original 3-D geometry may also be introduced in a corresponding 3-D visualization. For example, text and char information may be displayed orthogonally to the view direction and can be contextually attached to objects within the 3D visualization. For example, text labels may be attached to power outlets to display real time power use, etc.

In one embodiment, a user interface is provided to enable a user to select a building module from a plurality of building modules presented to the user on a computer screen. Upon selection, a 3-D visualization of the building module is displayed on the computer screen. The user may also select one or more environmental elements, such as temperature, air flow, light, etc. to be displayed on the computer screen in context of the displayed 3-D representation of the selected building module. A graphical representation of more than one environmental elements may be displayed through overlapping layers or using different colors, textures, shades, etc. Furthermore, the user may also select a second building module to view the graphical representations of environmental elements side-by-side.

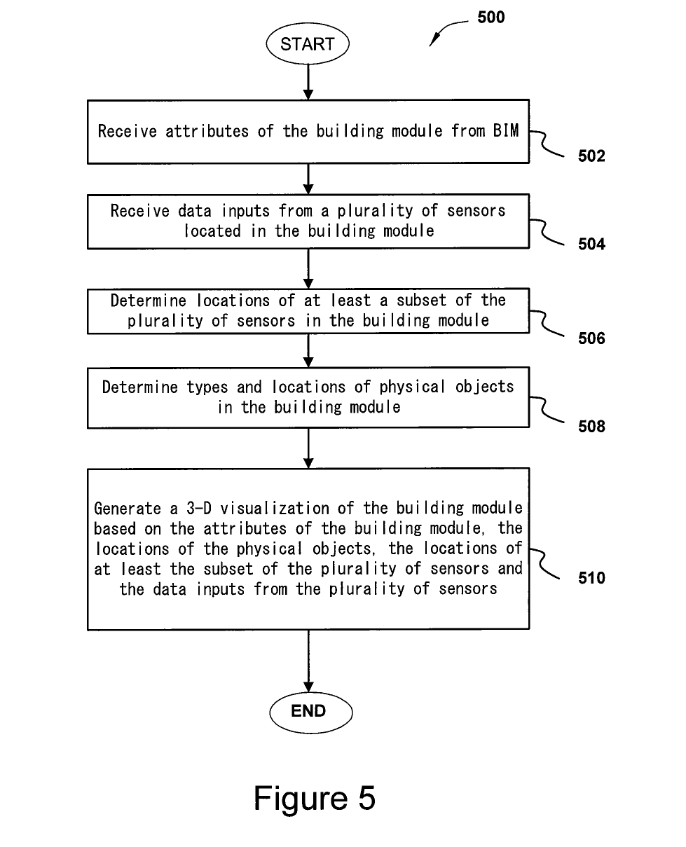

FIG. 5 illustrates a flow diagram 500 of a method of 3-D visualization of building module 210. Accordingly, at step 502, visualization processor 100 retrieves attributes of building module 210 from BIM system 204. In one embodiment, attributes are received as a part of BIM data model corresponding to building module 210. At step 504, visualization processor 100 receives data inputs from a plurality of sensors located in building module 210. Data inputs from sensors that are located outside of the building and also in proximity of building module 210 may also be received by visualization processor 100. At step 506, visualization processor 100 determines locations of at least a subset of the plurality of sensors 212 in building module 210. In another embodiment, locations of sensors that are installed outside building module 210 and outside the building itself may also be determined (e.g., from the corresponding BIM data models). In another embodiment, a processing unit that couples both sensors 212 and visualization processor 100 may determine said locations instead of visualization processor 100. At step 508, visualization processor 100 determines types and locations of physical objects in building module 210. In another example in which RFID readers are used, RFID readers may be able to determine said types and locations either independently or with the help of either visualization processor 100 or a control/processing unit that manages RFID readers. In one embodiment, the above steps should be executed in the sequence as listed above. However, in another embodiment, the above noted method steps may be executed out of order (e.g., step 508 may be executed prior to step 506). At step 510, visualization processor 100 in conjunction with visualization terminal 202 generates a 3-D visualization of building module 210 based on the attributes of building module 210 as retrieved from BIM system 204, the locations of the physical objects, the locations of at least the subset of the plurality of sensors and the data inputs from the plurality of sensors.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

We claim:

1. A computer implemented method of generating a 3-D representation of a building module, comprising:
receiving attributes of the building module from a data model of the building module;
receiving data inputs from a plurality of sensors located in the building module;
determining locations of at least a subset of the plurality of sensors in the building module; and
generating a 3-D representation of the building module for display on a computer screen based on the locations of at least the subset of the plurality of sensors and the data inputs from the plurality of sensors.

2. The computer implemented method of claim 1, wherein the locations of at least the subset of the plurality of sensors includes X, Y and Z coordinates of each of the subset of the plurality of sensors and the locations of at least the subset of the plurality of sensors are determined through a triangulation method.

3. The computer implemented method of claim 1, wherein the locations of at least the subset of the plurality of sensors includes X, Y and Z coordinates of each of the subset of the plurality of sensors and wherein the X, Y and Z coordinates of each of the subset of the plurality of sensors are received from the data model.

4. The computer implemented method of claim 1, wherein the types and locations of the physical objects are determined using a combination of radio frequency identification tags and Wi-Fi triangulation.

5. The computer implemented method of claim 1, wherein at least a subset of the plurality of sensors a same type of data values.

6. The computer implemented method of claim 5, wherein locations of at least a subject of the physical objects are calculated from varying data values received from the subset of the plurality of sensors of the same type.

7. The computer implemented method of claim 1, wherein the 3-D visualization includes at least one of a graphical visualization of heat sources, a graphical visualization of heat sinks, a visualization of light sources and a visualization real time power usage.

8. The computer implemented method of claim 7, wherein the graphical visualization of heat sources and the graphical visualization of heat sinks includes using arrows in a 3-D space to indicate sources and sinks.

9. A computer generated visualization dashboard, comprising:
a 3-D rendering on a computer screen, of a building module that includes geometrical features of the building module and one or more moveable physical objects inside the building module; and
a graphical representation of a source of an environmental element inside the building module including a direction of flow of the environmental element and intensity of the environmental element corresponding to the flow.

10. The computer generated visualization dashboard of claim 9, wherein the geometrical features are retrieved from an data model corresponding to the building module.

11. The computer generated visualization dashboard of claim 9, wherein the one or more moveable physical objects included in a data model corresponding to the building module.

12. The computer generated visualization dashboard of claim 11, wherein the data model is editable to add or remove the one or more moveable physical objects.

13. The computer generated visualization dashboard of claim 9, wherein the source of the environmental element is determined based on input data from a sensor in the building module.

14. The computer generated visualization dashboard of claim 9, wherein the flow is determined through a simulation of additional data points based on data inputs from a plurality of sensors.

15. The computer generated visualization dashboard of claim 14, wherein locations and types of the plurality of sensors are included in a data model corresponding to the building module.

16. A method of generating a 3-D representation of a building module, comprising:
selecting the building module from a plurality of building modules through a user interface on a computer screen;
providing input, through the user interface, to trigger the computer screen to display a 3-D representation of the building module, the 3-D representation including geometrical features of the building module; and
providing input, through the user interface, to trigger the computer screen to display a graphical representation of an environment element in the 3-D representation.

17. The method of claim 16, further including selecting a second building module from the plurality of building module and providing input, through the user interface, to display a 3-D representation of the second building module side-by-side.

18. The method of claim 16, further including providing input, through the user interface, to trigger the computer screen to display a graphical representation of a second environment element.

19. The method of claim 18, wherein the graphical representation of the environment element and the graphical representation of the second environment element are displayed through overlapping layers.

20. The method of claim 19, wherein the graphical representation of the environment element and the graphical representation of the second environment element are displayed using different shades or texture or color.
